(19) United States
(12) Patent Application Publication
(10) Pub. No.: US 2022/0343669 A1
(43) Pub. Date: Oct. 27, 2022

(54) METHOD, APPARATUS AND DEVICE FOR IDENTIFYING FINGERPRINT, DISPLAY DEVICE, AND STORAGE MEDIUM THEREOF

(71) Applicant: BOE TECHNOLOGY GROUP CO., LTD., Beijing (CN)

(72) Inventors: Liang Cui, Beijing (CN); Lei Wang, Beijing (CN); Yangbing Li, Beijing (CN); Yubo Wang, Beijing (CN); Xiufeng Li, Beijing (CN); Yuanyuan Ma, Beijing (CN)

(21) Appl. No.: 17/422,242

(22) PCT Filed: Sep. 29, 2020
(86) PCT No.: PCT/CN2020/118741

§ 371 Date: Jul. 12, 2021

(51) Int. Cl. G06V 40/13; G06V 40/12

(52) U.S. Cl. CPC G06V 40/1306; G06V 40/1335

(57) ABSTRACT

A method for identifying a fingerprint, includes: performing a plurality of signal load operations on a plurality of transmit electrodes; in response to performing the signal load operations on the transmit electrodes, acquiring a fingerprint signal by a target electrode of the receive electrodes; and identifying a fingerprint based on acquired fingerprint signals.

### CROSS-REFERENCE TO RELATED APPLICATIONS

This application is a 371 of PCT Application No. PCT/CN2020/118741, filed on Sep. 29, 2020, the disclosure of which is herein incorporated by reference in its entirety.

### TECHNICAL FIELD

The present disclosure relates to the field of fingerprint identification technologies, and in particular relates to a method, apparatus and device for identifying a fingerprint, a display device, and a storage medium thereof.

### BACKGROUND

With the continuous development of display technologies, the application scope of display panels with a fingerprint identification function is widened. At present, in a fingerprint identification display panel, the fingerprint identification function may be implemented using an ultrasonic fingerprint sensor disposed in the display panel. During the implementation of the fingerprint identification function, an identification structure is not affected by cleanliness of the touch fingerprint, and ultrasonic waves generated during the fingerprint identification are capable of penetrate many types of materials, such that an accuracy of fingerprint identification is not affected by the material of the product, which is more conducive to improving the accuracy of fingerprint identification.

### SUMMARY

Embodiments of the present disclosure provide a method, apparatus and device for identifying a fingerprint, a display device, and a storage medium thereof.

In one aspect, a method for identifying a fingerprint is provided, applicable to an ultrasonic fingerprint sensor including a plurality of transmit electrodes and a plurality of receive electrodes, the transmit electrodes being disposed to face the receive electrodes, the transmit electrodes being strip-shaped, and the receive electrodes being block-shaped. The method includes:

performing a plurality of signal load operations on the transmit electrodes, wherein the signal load operation includes: loading an excitation signal to at least two of the transmit electrodes sequentially, the at least two of the transmit electrodes being consecutively arranged;

in response to performing the signal load operations on the transmit electrodes, acquiring a fingerprint signal by a target electrode of the receive electrodes, the target electrode being a receive electrode facing a transmit electrode that finally receives the excitation signal in one signal load operation; and

identifying a fingerprint based on acquired fingerprint signals.

Optionally, loading the excitation signal to the at least two of the transmit electrodes sequentially includes:

loading the excitation signal to the at least two of the transmit electrodes sequentially along an arrangement direction of the at least two of the transmit electrodes.

Optionally, loading the excitation signal to the at least two of the transmit electrodes sequentially includes:

loading the excitation signal to the at least two of the transmit electrodes sequentially along an edge-to-center direction from two ends of an arrangement direction of the at least two of the transmit electrodes.

Optionally, loading the excitation signal to the at least two of the transmit electrodes sequentially along the edge-to-center direction from the two ends of the arrangement direction of the at least two of the transmit electrodes includes:

loading the excitation signal to the at least two of the transmit electrodes sequentially simultaneously along the edge-to-center direction from the two ends of the arrangement direction of the at least two of the transmit electrodes.

Optionally, loading the excitation signal to the at least two of the transmit electrodes sequentially along the edge-to-center direction from the two ends of the arrangement direction of the at least two of the transmit electrodes includes:

loading the excitation signal to the at least two of the transmit electrodes sequentially along the edge-to-center direction from one end of the arrangement direction of the at least two of the transmit electrodes; and

loading the excitation signal to the remaining of the at least two of the transmit electrodes sequentially along the edge-to-center direction from the other end of the arrangement direction of the at least two of the transmit electrodes.

Optionally, the receive electrodes include a plurality of rows of receive electrodes; and the transmit electrode that finally receives the excitation signal in each of the signal load operations corresponds to one row of the plurality of rows of receive electrodes; and

identifying the fingerprint based on the acquired fingerprint signals includes:

identifying the fingerprint based on fingerprint signals acquired by each row of receive electrodes.

Optionally, the identifying the fingerprint based on the fingerprint signal acquired by each row of receive electrodes includes:

generating a fingerprint image frame corresponding to each row of receive electrodes based on the fingerprint signal acquired by each row of receive electrodes;

splicing a plurality of fingerprint image frames respectively corresponding to the plurality of rows of receive electrodes to acquire a fingerprint image to be identified; and

identifying the fingerprint image to be identified.

Optionally, the number of the transmit electrodes is greater than the number of rows of the receive electrodes.

Optionally, the excitation signal includes a periodically changing sine wave voltage signal.

In another aspect, an apparatus for identifying a fingerprint is provided, applicable to an ultrasonic fingerprint sensor including a plurality of transmit electrodes and a plurality of receive electrodes, wherein the transmit electrodes are disposed to face the receive electrodes, the transmit electrodes are strip-shaped, and the receive electrodes are block-shaped. The apparatus includes:

a signal loading module, configured to perform a plurality of signal load operations on the transmit electrodes, wherein the signal load operation includes: loading an excitation signal to at least two of the transmit electrodes sequentially, the at least two of the transmit electrodes being consecutively arranged;

an acquiring module, configured to, in response to performing the signal load operations on the transmit electrodes, acquire a fingerprint signal by a target electrode of the receive electrodes, the target electrode being a receive electrode facing a transmit electrode that finally receives the excitation signal in one signal load operation; and

an identifying module, configured to identify a fingerprint based on acquired fingerprint signals.

In yet another aspect, a device for identifying a fingerprint is provided. The device includes: an ultrasonic fingerprint sensor, the ultrasonic fingerprint sensor including a plurality of transmit electrodes and a plurality of receive electrodes, the transmit electrodes being disposed to face the receive electrodes, the transmit electrodes being strip-shaped, and the receive electrodes being block-shaped; and

the device for identifying a fingerprint further includes: a processor and a memory storing an instruction executable by the processor, wherein the processor, when executing the at least one instruction, is caused to perform the method for identifying a fingerprint in any one of the above aspects.

Optionally, the ultrasonic fingerprint sensor further includes a piezoelectric material layer disposed between the transmit electrodes and the receive electrodes.

Optionally, the receive electrodes include a plurality of rows of receive electrodes, wherein the number of the transmit electrodes is greater than the number of rows of the receive electrodes.

In yet another aspect, a display device is provided. The display device includes: a display panel and a device for identifying a fingerprint in any one of the above aspects, wherein the ultrasonic fingerprint sensor in the device for identifying a fingerprint is disposed on a backlight side of the display panel.

In yet another aspect, a non-transitory computer-readable storage medium storing an instruction is provided, wherein the readable storage medium, when run by a processing component, causes the processing component to perform the method for identifying a fingerprint in any one of the above aspects.

### BRIEF DESCRIPTION OF THE DRAWINGS

For clearer descriptions of the technical solutions in the embodiments of the present disclosure, the following briefly introduces the accompanying drawings required for describing the embodiments. Apparently, the accompanying drawings in the following description show merely some embodiments of the present disclosure, and persons of ordinary skill in the art may still derive other drawings from these accompanying drawings without creative efforts.

FIG. 1 is a schematic diagram of a film structure of an ultrasonic fingerprint sensor in the related art;

FIG. 2 is a schematic diagram of the ultrasonic fingerprint sensor shown in FIG. 1 in response to transmitting ultrasonic waves;

FIG. 3 is a schematic diagram of the ultrasonic fingerprint sensor shown in FIG. 1 in response to receiving ultrasonic waves;

FIG. 4 is a schematic diagram of ultrasonic waves reflected by a finger;

FIG. 5 is a flowchart of a method for identifying a fingerprint according to an embodiment of the present disclosure;

FIG. 6 is a schematic diagram of a film structure of an ultrasonic fingerprint sensor according to an embodiment of the present disclosure;

FIG. 7 is a flowchart of another method for identifying a fingerprint according to an embodiment of the present disclosure;

FIG. 8 is an effect diagram of an arrangement of transmit electrodes that need to be loaded with an excitation signal in response to performing one signal load operation according to an embodiment of the present disclosure;

FIG. 9 is an effect diagram of another arrangement of transmit electrodes that need to be loaded with an excitation signal in response to performing one signal load operation according to an embodiment of the present disclosure;

FIG. 10 is a timing diagram of loading an excitation signal to 7 transmit electrodes consecutively arranged according to an embodiment of the present disclosure;

FIG. 11 is an energy distribution diagram of ultrasonic waves transmitted by the ultrasonic fingerprint sensor in the related art;

FIG. 12 is an energy distribution diagram of ultrasonic waves transmitted by the ultrasonic fingerprint sensor according to an embodiment of the present disclosure;

FIG. 13 is an effect diagram of performing a plurality of signal load operations on a plurality of transmit electrodes according to an embodiment of the present disclosure;

FIG. 14 is a schematic diagram of a plurality of fingerprint image frames generated in response to performing the plurality of signal load operations on the transmit electrodes shown in FIG. 13;

FIG. 15 is a schematic diagram of a fingerprint image acquired in response to splicing the plurality of fingerprint image frames shown in FIG. 14;

FIG. 16 is a schematic diagram of a fingerprint data frame according to an embodiment of the present disclosure;

FIG. 17 is a schematic diagram of a fingerprint image acquired in response to processing the fingerprint data frame shown in FIG. 16;

FIG. 18 is a block diagram of an apparatus for identifying a fingerprint according to an embodiment of the present disclosure; and

FIG. 19 is a schematic structural diagram of a display device according to an embodiment of the present disclosure.

### DETAILED DESCRIPTION

For clearer descriptions of the objectives, technical solutions, and advantages of the present disclosure, embodiments of the present disclosure are described in detail hereinafter referring to the accompanying drawings.

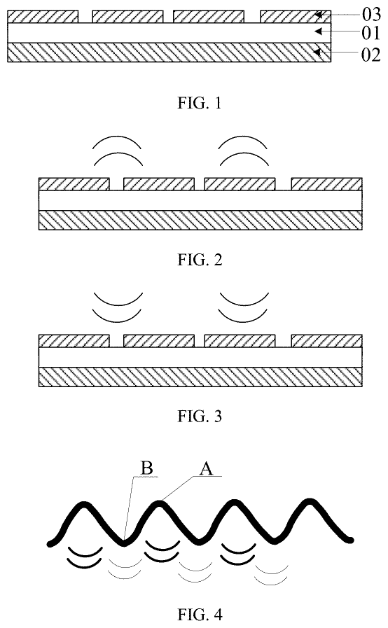

FIG. 1 shows a schematic diagram of a film structure of an ultrasonic fingerprint sensor in the related art. The ultrasonic fingerprint sensor may include a piezoelectric material layer 01, a transmit electrode 02 disposed on one side of the piezoelectric material layer, and a plurality of receive electrodes 03 disposed on the other side of the piezoelectric material layer 01. The transmit electrode 02 is plate-shaped. A boundary of an orthographic projection of the transmit electrode 02 on the piezoelectric material layer 01 may coincide with a boundary of the piezoelectric material layer 01. The receive electrode 03 may be block-shaped. The receive electrodes 03 may be arranged in an array into a plurality of rows and a plurality of columns.

For the principle of the ultrasonic fingerprint sensor transmitting ultrasonic waves, reference may be made to FIG. 2, which is a schematic diagram of the ultrasonic fingerprint sensor shown in FIG. 1 in response to transmitting ultrasonic waves. An AC voltage signal may be loaded to the transmit electrode 02. A fixed signal may be loaded to the receive electrode 03 (e.g., the receive electrode 03 may be controlled to be grounded). In this way, an alternating electric field may be generated between the transmit electrode 02 and the receive electrode 03. With the effect of the alternating electric field, the piezoelectric material layer 01 disposed between the transmit electrode 02 and the receive electrode 03 is deformed, or the piezoelectric material layer 01 drives the transmit electrode 02 and the receive electrode 03 to deform together, thereby emitting ultrasonic waves, and transmitting the ultrasonic waves through a medium (e.g., the film structure in the ultrasonic fingerprint sensor, air, and the like).

For the principle of the ultrasonic fingerprint sensor receiving ultrasonic waves, reference may be made to FIG. 3, which is a schematic diagram of the ultrasonic fingerprint sensor shown in FIG. 1 in response to receiving ultrasonic waves. A fixed signal may be loaded to the transmit electrode 02. The receive electrode 03 may be controlled to be in a floating state without signal loading. In this way, in response to receiving the ultrasonic waves, the piezoelectric material layer 01 disposed between the transmit electrode 02 and the receive electrode 03 may convert the ultrasonic waves into an AC voltage. The receive electrode 03 may output a corresponding signal.

In response to identifying a fingerprint with the ultrasonic fingerprint sensor, the ultrasonic fingerprint sensor transmits ultrasonic waves to be reflected by a finger on the ultrasonic fingerprint sensor. The ultrasonic fingerprint sensor may receive reflected ultrasonic waves, and output a corresponding fingerprint signal to identify a fingerprint of the finger. FIG. 4 is a schematic diagram of ultrasonic waves reflected by a finger. Interface impedances of a fingerprint valley A and a fingerprint ridge B in a fingerprint of the finger are different, wherein the position of the fingerprint valley A is equivalent to a cavity which is filled with air, an interface at the position of the fingerprint ridge B is the skin, and the impedance of air is generally lower than that of other media. In response to the ultrasonic waves hitting the finger, energy reflected at the fingerprint valley A is different from that energy reflected at the fingerprint ridge B is different, wherein the energy reflected at the fingerprint valley A is stronger, and the energy reflected at the fingerprint ridge B is weaker. In this way, the positions of the fingerprint valley A and the fingerprint ridge B may be determined by the fingerprint signals output by the receive electrodes 03.

However, in the related art, the transmit electrode 02 in the ultrasonic fingerprint sensor is plate-shaped. In response to loading an AC voltage signal to the plate-shaped transmit electrode 02, a voltage amplitude of the AC voltage signal cannot increase indefinitely, resulting in that amplitudes of the ultrasonic waves emitted by the piezoelectric material layer 01 has an upper limit. The signal amount of the fingerprint signal output by the receive electrode 03 (that is, the voltage amount of the AC voltage) is positively correlated with the amplitudes of the ultrasonic waves received by the piezoelectric material layer 01. Thus, the signal amount of the fingerprint signal output by the receive electrode 03 also has an upper limit, resulting in a poor fingerprint identification effect of the ultrasonic fingerprint sensor in the related art.

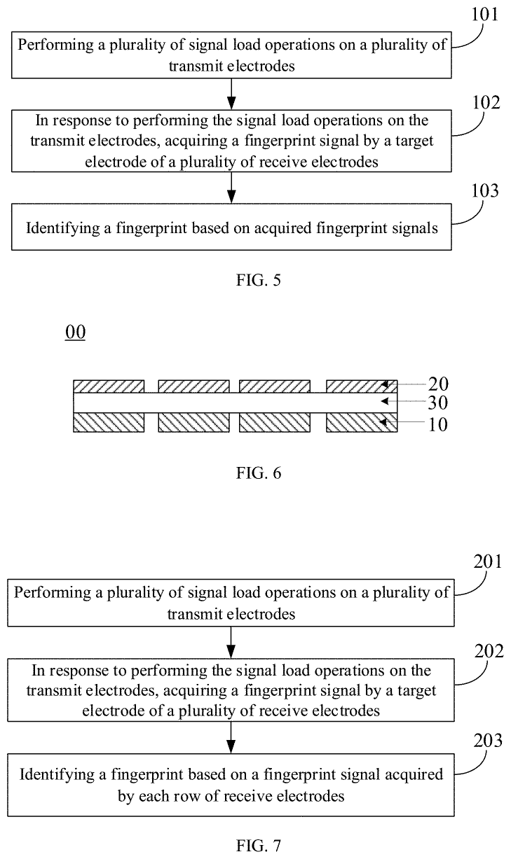

FIG. 5 is a flowchart of a method for identifying a fingerprint according to an embodiment of the present disclosure. The method is applicable to an ultrasonic fingerprint sensor.

In an exemplary embodiment, FIG. 6 is a schematic diagram of a film structure of an ultrasonic fingerprint sensor according to an embodiment of the present disclosure. The ultrasonic fingerprint sensor 00 may include a plurality of transmit electrodes 10 and a plurality of receive electrodes 20. The transmit electrodes 10 are disposed to face the receive electrodes 20. The transmit electrode 10 may be strip-shaped. The receive electrode 20 may be block-shaped. In the present disclosure, the ultrasonic fingerprint sensor 00 may further include a piezoelectric material layer 30 disposed between the transmit electrodes 10 and the receive electrodes 20.

As shown in FIG. 5, the method for identifying a fingerprint may include the steps described hereinafter.

In step 101, a plurality of signal load operations are performed on the transmit electrodes.

In the embodiment of the present disclosure, the signal load operation may include loading an excitation signal to at least two of the transmit electrodes sequentially, wherein the at least two of the transmit electrodes are consecutively arranged.

In step 102, in response to performing the signal load operations on the transmit electrodes, a fingerprint signal is acquired by a target electrode of the receive electrodes.

The target electrode is a receive electrode facing a transmit electrode that finally receives the excitation signal in one signal load operation. In an exemplary embodiment, the receive electrodes include a plurality of rows of receive electrodes which may face the transmit electrodes. Therefore, the target electrode refers to at least one row of receive electrodes among the receive electrodes.

In the embodiment of the present disclosure, in response to loading the excitation signal to the at least two of the transmit electrodes consecutively sequentially arranged, each transmit electrode loaded with the excitation signal causes the piezoelectric material layer to emit ultrasonic waves. Therefore, in response to performing one signal load operation, the piezoelectric material layer emits a plurality of sets of ultrasonic waves which can produce interference during the propagation process to exert an ultrasonic focusing effect, thereby effectively increasing amplitudes of the ultrasound waves emitted by the piezoelectric material layer. In response to reflecting the ultrasonic waves by the finger, the ultrasonic wave with a maximum amplitude is directed towards the target electrode of the receive electrodes, such that the target electrode is capable acquiring the signal amount of the fingerprint signal with a large signal amount.

In step 103, a fingerprint is identified based on acquired fingerprint signals.

In the embodiment of the present disclosure, in response to performing each signal load operation on the transmit electrodes, at least one row of the receive electrodes may be used as target electrodes to acquire fingerprint signals. In this way, in response to performing the plurality of signal load operations on the transmit electrodes, each row of the receive electrodes may acquire a fingerprint signal. The fingerprint may be identified based on the acquired fingerprint signals.

In summary, in the method for identifying a fingerprint according to the embodiments of the present disclosure, a plurality of signal load operations are performed on a plurality of strip-shaped transmit electrodes, such that each transmit electrode loaded with an excitation signal causes a piezoelectric material layer to emit ultrasonic waves. Therefore, in response to performing one signal load operation, the piezoelectric material layer emits a plurality of sets of ultrasonic waves which can produce interference during the propagation process to exert an ultrasonic focusing effect, thereby effectively increasing amplitudes of the ultrasound waves emitted by the piezoelectric material layer. Among ultrasonic waves reflected back, the ultrasonic wave with a maximum amplitude is directed towards a target electrode of the receive electrodes, such that the target electrode is capable acquiring a fingerprint signal with a large signal amount. In this way, in response to performing the plurality of signal load operations on the transmit electrodes, each of the receive electrodes is capable acquiring a fingerprint signal. In response to identifying a fingerprint based on these acquired fingerprint signals, the effect of fingerprint identification may be efficiently improved.

FIG. 7 is a flowchart of another method for identifying a fingerprint according to an embodiment of the present disclosure. The method is applicable to the ultrasonic fingerprint sensor shown in FIG. 6 and includes the steps described hereinafter.

In step 201, a plurality of signal load operations are performed on a plurality of transmit electrodes.

In the embodiment of the present disclosure, the signal load operation includes loading an excitation signal to at least two of the transmit electrodes sequentially, wherein the at least two of the transmit electrodes are consecutively arranged. In an exemplary embodiment, the excitation signal loaded to the transmit electrode may include a periodically changing sine wave voltage signal. For example, the periodically changing sine wave voltage signal may be a sine wave voltage signal of ±90 volts.

In the embodiment of the present disclosure, the signal load operations may be performed on the transmit electrodes in various ways. The two optional implementations described hereinafter are taken as examples for illustration in the embodiment of the present disclosure.

In a first optional implementation, in each signal load operation, an excitation signal may be loaded to two or more transmit electrodes consecutively arranged. The signal load operation may include loading the excitation signal to the at least two of the transmit electrodes sequentially along an arrangement direction of the at least two of the transmit electrodes.

In an exemplary embodiment, FIG. 8 is an effect diagram of an arrangement of transmit electrodes that need to be loaded with an excitation signal in response to performing one signal load operation according to an embodiment of the present disclosure. In each signal load operation, an excitation signal may be loaded to the at least two of the transmit electrodes consecutively sequentially arranged along a direction a or a direction b according to an arrangement sequence of the at least two of the transmit electrodes.

For example, the at least two of the transmit electrodes consecutively arranged include a transmit electrode C, a transmit electrode D, and transmit electrodes disposed between the transmit electrode C and the transmit electrode D. In response to performing the signal load operation on the at least two of the transmit electrodes consecutively arranged, the excitation signal may be loaded to each transmit electrode sequentially in a sequence from the transmit electrode C to the transmit electrode D or in a sequence from the transmit electrode D to the transmit electrode C.

In a second optional implementation, in each signal load operation, an excitation signal may be loaded to three or more transmit electrodes consecutively arranged. The signal load operation may include loading the excitation signal to the at least two of the transmit electrodes sequentially along an edge-to-center direction from the two ends of the arrangement direction of the at least two of the transmit electrodes.

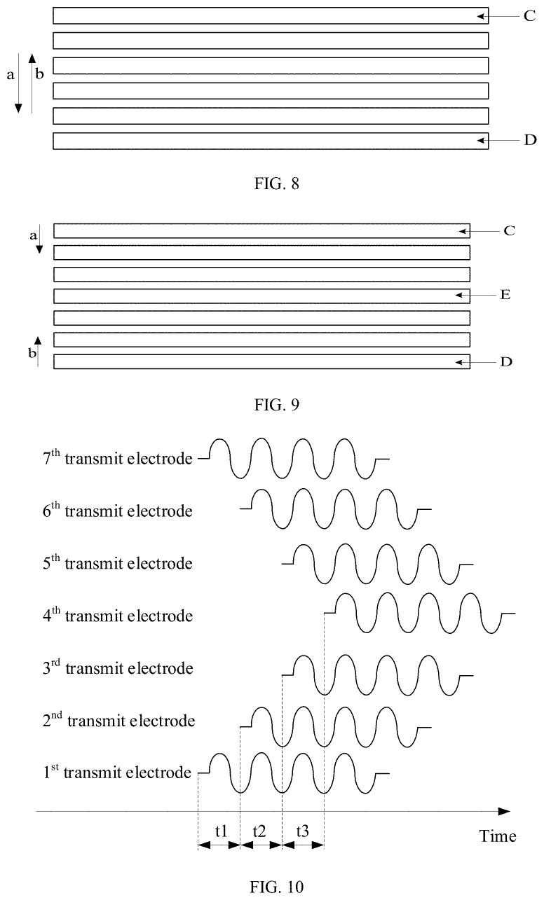

In an exemplary embodiment, FIG. 9 is an effect diagram of another arrangement of transmit electrodes that need to be loaded with an excitation signal in response to performing one signal load operation according to an embodiment of the present disclosure. In each signal load operation, the excitation signal may be loaded to the at least two of the transmit electrodes consecutively sequentially arranged along the direction a and the direction b according to the arrangement sequence of the at least two of the transmit electrodes.

For example, the at least two of the transmit electrodes consecutively arranged include a transmit electrode C, a transmit electrode D, a transmit electrode E disposed between the transmit electrode C and the transmit electrode D, a transmit electrode arranged between the transmit electrode C and the transmit electrode E, and a transmit electrode arranged between the transmit electrode D and the transmit electrode E. In response to performing the signal load operation on the at least two of the transmit electrodes consecutively arranged, the excitation signal may be loaded to each transmit electrode sequentially in a sequence from the transmit electrode C to the transmit electrode E and in a sequence from the transmit electrode D to the transmit electrode E.

For the second optional implementation, the two situations described hereinafter exist according to the loading timing of the excitation signal.

In a first case, loading the excitation signal to the transmit electrodes sequentially along the edge-to-center direction from the two ends of the arrangement direction of the at least two of the transmit electrodes may include: loading the excitation signal to the transmit electrodes sequentially simultaneously along the edge-to-center direction from the two ends of the arrangement direction of the at least two of the transmit electrodes.

For example, as shown in FIG. 9, in response to performing the signal load operation on the at least two of the transmit electrodes consecutively arranged, the excitation signal may be loaded to each transmit electrode sequentially along the direction a and the direction b simultaneously. For example, the excitation signals on the transmit electrode C and the transmit electrode D are loaded simultaneously.

In this case, a distance between the transmit electrode E and the transmit electrode C is the same as a distance between the transmit electrode E and the transmit electrode D. For example, in response to the number of transmit electrodes consecutively arranged being three or more, the number of transmit electrodes arranged between the transmit electrode E and the transmit electrode C is the same as the number of transmit electrodes arranged between the transmit electrode E and the transmit electrode D.

It should be noted that in response to the number of transmit electrodes consecutively arranged being an even number, the number of transmit electrodes E is two; and in response to the number transmit electrodes consecutively arranged being an odd number, the number of transmit electrodes E is one.

In a second case, loading the excitation signal to the at least two of the transmit electrodes sequentially along the edge-to-center direction from the two ends of the arrangement direction of the at least two of the transmit electrodes may include: loading the excitation signal to the at least two of the transmit electrodes sequentially along the edge-to-center direction from one end of the arrangement direction of the at least two of the transmit electrodes; and loading the excitation signal to the remaining of the at least two of the transmit electrodes sequentially along the edge-to-center direction from the other end of the arrangement direction of the at least two of the transmit electrodes.

For example, as shown in FIG. 9, in response to performing the signal load operation on the at least two of the transmit electrodes consecutively arranged, the excitation signal may be loaded to the transmit electrodes sequentially along the direction a and then along the direction b. For example, the excitation signal may be loaded to the transmit electrode C, a transmit electrode disposed between the transmit electrode C and the transmit electrode E, and the transmit electrode E sequentially along the direction a. Then, the excitation signal may be loaded to the transmit electrode D and a transmit electrode between the transmit electrode D and the transmit electrode E sequentially along the direction b.

It should be noted that in both of the above two optional implementations, signal load operations may be performed on the transmit electrode.

In the embodiment of the present disclosure, in response to loading the excitation signal to the at least two of the transmit electrodes consecutively arranged, the time interval may be several nanoseconds or tens of nanoseconds. The timing of loading the excitation signal to the at least two of the transmit electrodes may be acquired by performing a plurality of simulations on the ultrasonic waves emitted by the piezoelectric material layer. In response to loading the excitation signal to the at least two of the transmit electrodes with the timing acquired by simulation, each transmit electrode loaded with the excitation signal causes the piezoelectric material layer to emit a plurality of sets of ultrasonic waves which can produce interference to exert an ultrasonic focusing effect, thereby effectively increasing the amplitudes of the ultrasonic waves emitted by the piezoelectric material layer.

In an exemplary embodiment, FIG. 10 is a timing diagram of loading an excitation signal to seven transmit electrodes consecutively arranged according to an embodiment of the present disclosure. In response to loading the excitation signal to the seven transmit electrodes consecutively arranged in accordance with the first case of the second implementation, the excitation signal may be loaded to the 1^{st} transmit electrode and the 7^{th} transmit electrode simultaneously. Then, the excitation signal may be loaded to the 2^{nd} transmit electrode and the 6^{th} transmit electrode simultaneously. Then, the excitation signal may be loaded to the 3^{rd} transmit electrode and the 5^{th} transmit electrode simultaneously. Finally, the excitation signal may be loaded to the 4^{th} transmit electrode.

A time interval between the time of loading the excitation signal to the 1^{st} transmit electrode and the time of loading the excitation signal to the 2^{nd} transmit electrode is t1. A time interval between the time of loading the excitation signal to the 2^{nd} transmit electrode and the time of loading the excitation signal to the 3^{rd} transmit electrode is t2. A time interval between the time of loading the excitation signal to the 3^{rd} transmit electrode and the time of loading the excitation signal to the 4^{th} transmit electrode is t3. It should be noted that the durations of t1, t2, and t3 are different but may all be several nanoseconds or tens of nanoseconds. T1, t2, and t3 may all be acquired by performing a plurality of simulations on the ultrasonic waves emitted by the piezoelectric material layer. In response to loading the excitation signal to the 7 transmit electrodes according to the timing shown in FIG. 10, each transmit electrode loaded with the excitation signal causes the piezoelectric material layer to emit a plurality of sets of ultrasonic waves which can produce an interference phenomenon.

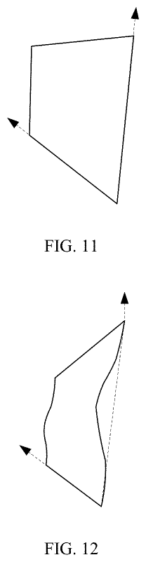

For example, FIG. 11 is an energy distribution diagram of ultrasonic waves transmitted by the ultrasonic fingerprint sensor in the related art, and FIG. 12 is an energy distribution diagram of ultrasonic waves transmitted by the ultrasonic fingerprint sensor according to an embodiment of the present disclosure. In the related art, the energy of the ultrasonic waves transmitted by the ultrasonic fingerprint sensor at various positions is approximately the same. However, in the embodiment of the present disclosure, the ultrasonic waves transmitted by the ultrasonic fingerprint sensor produces an interference phenomenon, and therefore, the energy of the ultrasonic waves in the central position (i.e., the position where the interference phenomenon is strongest) is significantly high. Thus, in case that the same AC voltage is provided to the transmit electrodes, the wave peak of the ultrasonic waves transmitted by the ultrasonic fingerprint sensor in the present disclosure is approximately 1.3 times the wave peak of the ultrasonic waves transmitted by the ultrasonic fingerprint sensor in the related art.

In step 202, in response to performing the signal load operations on the transmit electrodes, a fingerprint signal is acquired by a target electrode of the receive electrodes.

The target electrode may be a receive electrode facing a transmit electrode that finally receives the excitation signal in one signal load operation. In an exemplary embodiment, the receive electrodes include a plurality of rows of receive electrodes facing the transmit electrodes. Therefore, the target electrode refers to at least one row of the receive electrodes.

In the embodiment of the present disclosure, in response to performing one signal load operation on the transmit electrodes, the piezoelectric material layer emits a plurality of sets of ultrasonic waves which can produce interference during the propagation process to exert an ultrasonic focusing effect, thereby making amplitudes of the ultrasonic waves emitted by the piezoelectric material layer relatively large. In addition, the ultrasonic wave with a maximum amplitude in the ultrasonic waves faces the transmit electrode that finally receives the excitation signal. Therefore, in response to reflecting the ultrasonic waves by a finger, the ultrasonic wave with the maximum amplitude is directed towards the target electrode of the receive electrodes, such that the target electrode is capable of acquiring a fingerprint signal with large signal amount.

It should be noted that all the receive electrodes in the ultrasonic fingerprint sensor in the present disclosure are capable acquiring fingerprint signals. Therefore, the receive electrodes may be arranged in a plurality of rows, and each row of receive electrodes faces one transmit electrode.

It should also be noted that in response to loading the excitation signal to each transmit electrode during the signal load operation in accordance with the first case in the second implementation described above, if the number of transmit electrodes to be loaded with the excitation signal during the signal load operation is an odd number, the transmit electrode disposed in the middle is the transmit electrode that finally receives the excitation signal, in which case, the target electrode is one row of receive electrodes; and if the number of transmit electrodes to be loaded with the excitation signal during the signal load operation is an even number, the two transmit electrodes in the middle are the transmit electrodes that finally receive the excitation signal, in which case, the target electrode is two rows of receive electrodes.

Optionally, in response to performing the plurality of signal load operations on the transmit electrodes, the transmit electrode that finally receives the excitation signal in each signal load operation corresponds to one row of the plurality of rows of receive electrodes. For example, in response to the number of transmit electrodes that finally receive the excitation signal in each signal load operation being 1, assuming that the receive electrodes are arranged in n rows, n signal load operations need to be performed, such that each of the n rows of receive electrodes is capable of acquiring a fingerprint signal. In this case, the number of transmit electrodes needs to be greater than the number of rows of receive electrodes to ensure that each row of receive electrodes us capable of acquiring a fingerprint signal.

In an exemplary embodiment, FIG. 13 is an effect diagram of performing a plurality of signal load operations on a plurality of transmit electrodes according to an embodiment of the present disclosure. Assuming that the number of transmit electrodes is m, the plurality of signal load operations may be performed on the m transmit electrodes sequentially according to an arrangement sequence thereof. For example, in response to performing a 1^{st} signal load operation on the m transmit electrodes, a 1^{st} row of the receive electrodes may acquire a fingerprint signal. In response to performing an n^{th} signal load operation on the m transmit electrodes, an n^{th} row of the receive electrodes may acquire a fingerprint signal, where m and n are both positive integers, and m is greater than n.

In step 203, a fingerprint is identified based on a fingerprint signal acquired by each row of receive electrodes.

In the embodiment of the present disclosure, each row of the receive electrodes is capable of acquiring a fingerprint signal. Therefore, the fingerprint may be identified based on the fingerprint signal acquired by each row of receive electrodes.

In an exemplary embodiment, identifying the fingerprint based on the fingerprint signal acquired by each row of receive electrodes may include the steps described hereinafter.

In step 2031, a fingerprint image frame corresponding to each row of receive electrodes is generated based on the fingerprint signal acquired by each row of receive electrodes.

In the embodiment of the present disclosure, the ultrasonic fingerprint sensor may perform non-uniformity correction and data processing on the fingerprint signal acquired by each row of receive electrodes, and then generate a fingerprint image frame corresponding to each row of receive electrodes.

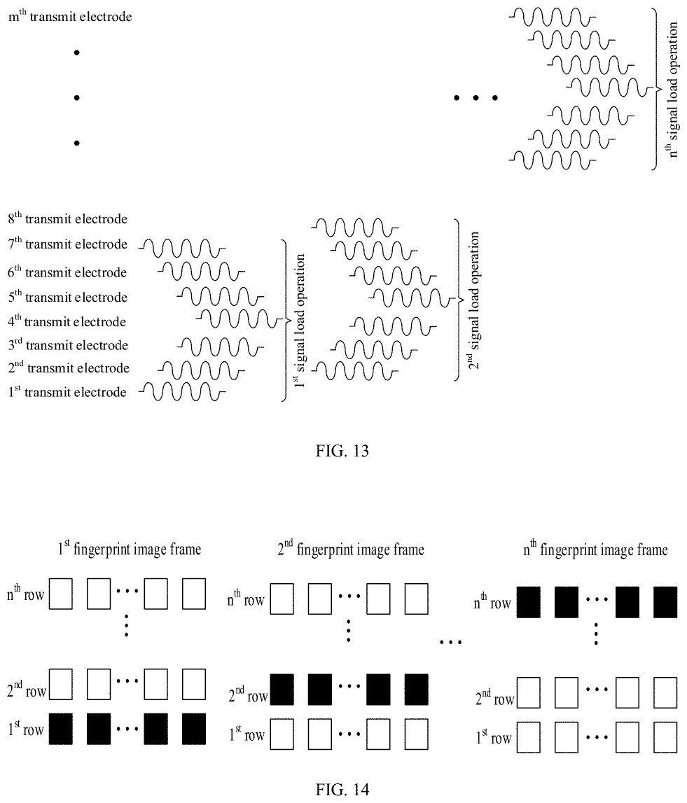

In an exemplary embodiment, FIG. 14 is a schematic diagram of a plurality of fingerprint image frames generated in response to performing the plurality of signal load operations on the transmit electrodes as shown in FIG. 13. In response to performing non-uniformity correction and data processing on the fingerprint signal acquired by the 1^{st} row of the receive electrodes, a 1^{st} fingerprint image frame corresponding to the 1^{st} row of receive electrodes may be generated. In response to performing non-uniformity correction and data processing on the fingerprint signal acquired by the n^{th} row of the receive electrodes, an n^{th} fingerprint image frame corresponding to the n^{th} row of receive electrodes may be generated. In this way, by step 2031, the ultrasonic fingerprint sensor may generate n fingerprint image frames.

In step 2032, a plurality of fingerprint image frames respectively corresponding to the plurality of rows of receive electrodes are spliced to acquire a fingerprint image to be identified.

In the embodiments of the present disclosure, the ultrasonic fingerprint sensor may splice the plurality of fingerprint image frames respectively corresponding to the plurality of rows of receive electrodes to acquire a complete fingerprint image, which can subsequently be used as the fingerprint image to be identified and then identified accordingly.

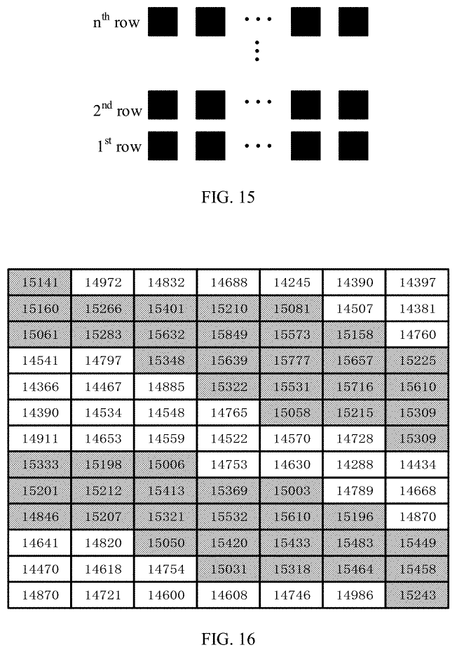

In an exemplary embodiment, FIG. 15 is a schematic diagram of a fingerprint image acquired in response to splicing the plurality of fingerprint image frames shown in FIG. 14. In response to acquiring n fingerprint image frames in step 2031, the n fingerprint image frames may be spliced to acquire a complete fingerprint image.

It should be noted that in other optional implementations, a fingerprint data frame may be generated based on the fingerprint signal acquired by each row of receive electrodes, and then non-uniformity correction and data processing may be performed on the fingerprint data frame to acquire a complete fingerprint image.

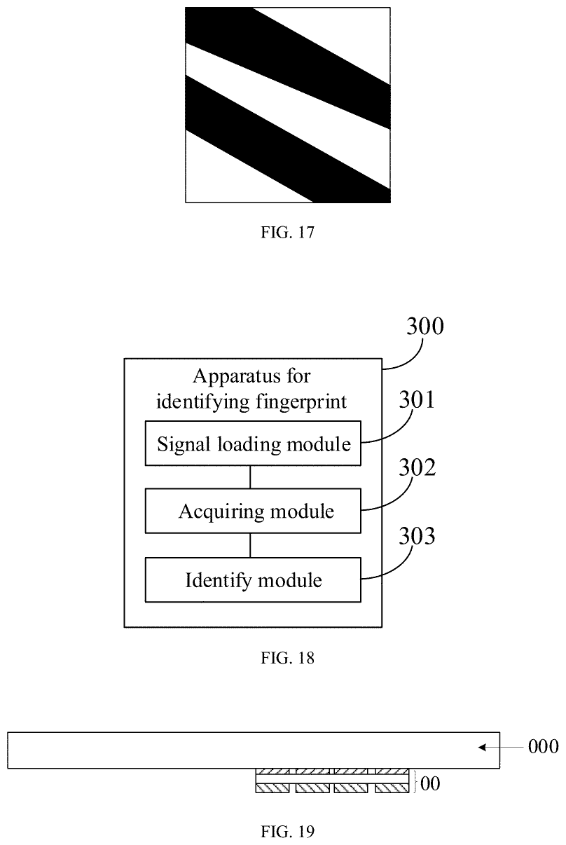

For example, FIG. 16 is a schematic diagram of a fingerprint data frame according to an embodiment of the present disclosure, and FIG. 17 is a schematic diagram of a fingerprint image acquired in response to processing the fingerprint data frame shown in FIG. 16. In FIG. 16, the number in each block may indicate the signal amount of the fingerprint signal acquired by one receive electrode. The fingerprint includes fingerprint valleys and fingerprint ridges, such that the energy of ultrasonic waves reflected at the fingerprint valley and fingerprint ridge is different. Therefore, by determining the distribution range of the signal amount of the fingerprint signal acquired by the receive electrode, the positions of the fingerprint valleys and the fingerprint ridges in the fingerprint may be determined. For example, in FIG. 16, the white filled blocks may indicate the positions of the fingerprint ridges, and the shadow filled blocks may indicate the positions of the fingerprint valleys. In response to processing the fingerprint data frame shown in FIG. 16, the fingerprint image shown in FIG. 17 may be acquired. In the fingerprint image, the white curves may indicate the positions of the fingerprint ridges, and the black curves may indicate the positions of the fingerprint valleys.

In step 2033, the fingerprint image to be identified is identified.

In the embodiment of the present disclosure, the ultrasonic fingerprint sensor may identify the fingerprint image to be identified to authenticate the fingerprint image.

It should be noted that, by steps 201 to 203, a fingerprint image may be acquired in one fingerprint acquisition cycle, and the fingerprint image may be identified. In response to the ultrasonic fingerprint sensor operating, it is necessary to periodically perform steps 201 to 203 with steps 201 to 203 as a cycle.

It should also be noted that the sequence of the steps of the method for identifying a fingerprint according to the embodiments of the present disclosure may be adjusted appropriately, and the steps may also be added or deleted as required. Any variations that may be easily conceived by those skilled in the art within the scope of the technology disclosed in the present disclosure shall be covered by the scope of protection of the present disclosure and are not repeated.

In summary, in the method for identifying a fingerprint according to the embodiments of the present disclosure, a plurality of signal load operations are performed on a plurality of strip-shaped transmit electrodes, such that each transmit electrode loaded with an excitation signal causes a piezoelectric material layer to emit ultrasonic waves. Therefore, in response to performing one signal load operation, the piezoelectric material layer emits a plurality of sets of ultrasonic waves which can produce interference during the propagation process to exert an ultrasonic focusing effect, thereby effectively increasing amplitudes of the ultrasound waves emitted by the piezoelectric material layer. Among ultrasonic waves reflected back, the ultrasonic wave with a maximum amplitude is directed towards a target electrode of the receive electrodes, such that the target electrode is capable of acquiring a fingerprint signal with a large signal amount. In this way, in response to performing the plurality of signal load operations on the transmit electrodes, each of the receive electrodes is capable of acquiring a fingerprint signal. In response to identifying a fingerprint based on these acquired fingerprint signals, the effect of fingerprint identification may be efficiently improved.

An embodiment of the present disclosure also provides an apparatus for identifying a fingerprint. FIG. 18 is a block diagram of an apparatus for identifying a fingerprint according to an embodiment of the present disclosure. The apparatus 300 for identifying a fingerprint is applicable to the ultrasonic fingerprint sensor shown in FIG. 6 and may include:

a signal loading module 301, configured to perform a plurality of signal load operations on a plurality of transmit electrodes, wherein the signal load operation includes: loading an excitation signal to at least two of the transmit electrodes sequentially, the at least two of the transmit electrodes being consecutively arranged;

an acquiring module 302, configured to, in response to performing the signal load operations on the transmit electrodes, acquire a fingerprint signal by a target electrode of the receive electrodes, the target electrode being a receive electrode facing a transmit electrode that finally receives the excitation signal in one signal load operation; and

an identifying module 303, configured to identify a fingerprint based on acquired fingerprint signals.

In summary, in the apparatus for identifying a fingerprint according to the embodiments of the present disclosure, a plurality of signal load operations are performed on a plurality of strip-shaped transmit electrodes, such that each transmit electrode loaded with an excitation signal causes a piezoelectric material layer to emit ultrasonic waves. Therefore, in response to performing one signal load operation, the piezoelectric material layer emits a plurality of sets of ultrasonic waves which can produce interference during the propagation process to exert an ultrasonic focusing effect, thereby effectively increasing amplitudes of the ultrasound waves emitted by the piezoelectric material layer. Among ultrasonic waves reflected back, the ultrasonic wave with a maximum amplitude is directed towards a target electrode of the receive electrodes, such that the target electrode is capable of acquiring a fingerprint signal with a large signal amount. In this way, in response to performing the plurality of signal load operations on the transmit electrodes, each of the receive electrodes is capable of acquiring a fingerprint signal. In response to identifying a fingerprint based on these acquired fingerprint signals, the effect of fingerprint identification may be efficiently improved.

Optionally, the signal loading module 301 is configured to load the excitation signal to the at least two of the transmit electrodes sequentially along an arrangement direction of the at least two of the transmit electrodes.

Optionally, the signal loading module 301 is configured to load the excitation signal to the at least two of the transmit electrodes sequentially along an edge-to-center direction from two ends of an arrangement direction of the at least two of the transmit electrodes.

Optionally, the signal loading module 301 is configured to load the excitation signal to the at least two of the transmit electrodes sequentially simultaneously along the edge-to-center direction from the two ends of the arrangement direction of the at least two of the transmit electrodes.

Optionally, the signal loading module 301 is configured to load the excitation signal to the at least two of the transmit electrodes sequentially along the edge-to-center direction from one end of the arrangement direction of the at least two of the transmit electrodes; and load the excitation signal to the remaining of the at least two of the transmit electrodes sequentially along the edge-to-center direction from the other end of the arrangement direction of the at least two of the transmit electrodes.

Optionally, the receive electrodes include a plurality of rows of receive electrodes; and the transmit electrode that finally receives the excitation signal in each of the plurality of signal load operations corresponds to one of the plurality of rows of receive electrodes. The identifying module 303 is configured to identify the fingerprint based on a fingerprint signal acquired by each row of receive electrodes.

Optionally, the identifying module 303 is configured to generate a fingerprint image frame corresponding to each row of receive electrodes based on the fingerprint signal acquired by each row of receive electrodes; splice a plurality of fingerprint image frames respectively corresponding to the plurality of rows of receive electrodes to acquire a fingerprint image to be identified; and identify the fingerprint image to be identified.

Optionally, the number of transmit electrodes is greater than the number of rows of the receive electrodes.

Optionally, the excitation signal includes a periodically changing sine wave voltage signal.

In summary, in the apparatus for identifying a fingerprint according to the embodiments of the present disclosure, a plurality of signal load operations are performed on a plurality of strip-shaped transmit electrodes, such that each transmit electrode loaded with an excitation signal causes a piezoelectric material layer to emit ultrasonic waves. Therefore, in response to performing one signal load operation, the piezoelectric material layer emits a plurality of sets of ultrasonic waves which can produce interference during the propagation process to exert an ultrasonic focusing effect, thereby effectively increasing amplitudes of the ultrasound waves emitted by the piezoelectric material layer. Among ultrasonic waves reflected back, the ultrasonic wave with a maximum amplitude is directed towards a target electrode of the receive electrodes, such that the target electrode is capable of acquiring a fingerprint signal with a large signal amount. In this way, in response to performing the plurality of signal load operations on the transmit electrodes, each of the receive electrodes is capable of acquiring a fingerprint signal. In response to identifying a fingerprint based on these acquired fingerprint signals, the effect of fingerprint identification may be efficiently improved.

An embodiment of the present disclosure also provides a device for identifying a fingerprint which may include an ultrasonic fingerprint sensor. In an exemplary embodiment, as shown in FIG. 6, the ultrasonic fingerprint sensor 00 may include a plurality of transmit electrodes 10 and a plurality of receive electrodes 20. The transmit electrodes 10 are disposed to face the receive electrodes 20. The transmit electrode 10 may be strip-shaped, and the receive electrode 20 may be block-shaped. In the present disclosure, the ultrasonic fingerprint sensor 00 may further include a piezoelectric material layer 30 disposed between the transmit electrodes 10 and the receive electrodes 20.

In the embodiment of the present disclosure, the device for identifying a fingerprint may further include a processor and a memory for storing an instruction executable by the processor. The processor is configured to perform the method for identifying a fingerprint as shown in FIG. 5 or FIG. 7.

Optionally, the receive electrodes 20 include a plurality of rows of receive electrodes, wherein the number of transmit electrodes 10 is greater than the number of rows of receive electrodes 20.

Optionally, the material of the piezoelectric material layer 30 may include polyvinylidene fluoride (PVDF), lead lanthanum zirconate titanate ceramic (PLZT), aluminum nitride (ALN), cadmium sulfide (CdS), barium titanium trioxide (BaTiO3) and the like.

An embodiment of the present disclosure also provides a display device, which may be any product or component with a display function such as an electronic paper, a mobile phone, a tablet, a television, a monitor, a laptop, a digital photo frame, a navigator, and the like. FIG. 19 is a schematic structural diagram of a display device according to an embodiment of the present disclosure. The display device may include a display panel 000 and a device for identifying a fingerprint. The device for identifying a fingerprint may be the device for identifying a fingerprint in the above embodiment. The ultrasonic fingerprint sensor 00 in the device for identifying a fingerprint may be the ultrasonic fingerprint sensor shown in FIG. 6. The ultrasonic fingerprint sensor 00 may be disposed on a backlight side of the display panel. In this case, the display device may be a display device with an under-screen fingerprint identification function. In response to a user's finger locating directly above the ultrasonic fingerprint sensor 00, the ultrasonic fingerprint sensor 00 is capable of acquiring and identifying a fingerprint of the finger. For example, the ultrasonic fingerprint sensor 00 may perform the method for identifying a fingerprint as shown in FIG. 5 or FIG. 7 to identify the user's fingerprint.

An embodiment of the present disclosure also provides a computer-readable storage medium storing an instruction therein. The readable storage medium, when run by a processing component, causes the processing component to perform the method for identifying a fingerprint as shown in FIG. 5 or FIG. 7.

It should be pointed out that in the accompanying drawings, the sizes of layers and regions may be exaggerated for clarity of illustration. It will also be understood that when an element or layer is interpreted as being “on” another element or layer, it may be directly on the other element or an intervening layer may be present. In addition, it will be understood that when an element or layer is interpreted as being “under” another element or layer, it may be directly under the other element, or more than one intervening layer or element may be present. In addition, it can also be understood that when a layer or element is interpreted as being “between” two layers or two elements, it may be the only layer between the two layers or two elements, or more than one intervening layer or component may also be present. Similar reference numerals indicate similar elements throughout.

In the present disclosure, the terms “first” and “second” are only used for description purposes, and cannot be understood as indicating or implying relative importance. The term “a plurality of” indicates two or more, unless specifically defined otherwise. The singular forms “a,” “an,” and “the” include both singular and plural referents unless the context clearly dictates otherwise. Thus, for example, reference to “a computer-readable storage medium storing an instruction” includes one or more computer-readable storage mediums that include plurality of instructions as well as a single computer-readable storage medium consisting of a single instruction, reference to “an instruction” includes a combination of instructions as well as a single instruction, and the like.

Those skilled in the art can understand that all or part of the steps in the above embodiments may be performed by hardware, or by a program to instruct related hardware. The program may be stored in a computer-readable storage medium which may be a read-only memory, a magnetic disk or an optical disk, and the like.

Above-mentioned embodiments are merely exemplary embodiments of the present disclosure, but are not intended to limit the present disclosure. Any modifications, equivalent replacements, improvements and the like made within the spirit and principles of the present disclosure should be included within the scope of protection of the present disclosure.

What is claimed is:

1. A method for identifying a fingerprint, applicable to an ultrasonic fingerprint sensor comprising a plurality of transmit electrodes and a plurality of receive electrodes, the transmit electrodes being disposed to face the receive electrodes, the transmit electrodes being strip-shaped, and the receive electrodes being block-shaped;
the method comprising:
performing a plurality of signal load operations on the transmit electrodes, wherein the signal load operation comprises: loading an excitation signal to at least two of the transmit electrodes sequentially, the at least two of the transmit electrodes being consecutively arranged;
in response to performing the signal load operations on the transmit electrodes, acquiring a fingerprint signal by a target electrode of the receive electrodes, the target electrode being a receive electrode facing a transmit electrode that finally receives the excitation signal in one signal load operation; and
identifying a fingerprint based on acquired fingerprint signals.

2. The method according to claim 1, wherein loading the excitation signal to the at least two of the transmit electrodes sequentially comprises:
loading the excitation signal to the at least two of the transmit electrodes sequentially along an arrangement direction of the at least two of the transmit electrodes.

3. The method according to claim 1, wherein loading the excitation signal to the at least two of the transmit electrodes sequentially comprises:
loading the excitation signal to the at least two of the transmit electrodes sequentially along an edge-to-center direction from two ends of an arrangement direction of the at least two of the transmit electrodes.

4. The method according to claim 3, wherein loading the excitation signal to the at least two of the transmit electrodes sequentially along the edge-to-center direction from the two ends of the arrangement direction of the at least two of the transmit electrodes comprises:
loading the excitation signal to the at least two of the transmit electrodes sequentially simultaneously along the edge-to-center direction from the two ends of the arrangement direction of the at least two of the transmit electrodes.

5. The method according to claim 3, wherein loading the excitation signal to the at least two of the transmit electrodes sequentially along the edge-to-center direction from the two ends of the arrangement direction of the at least two of the transmit electrodes comprises:
loading the excitation signal to the at least two of the transmit electrodes sequentially along the edge-to-center direction from one end of the arrangement direction of the at least two of the transmit electrodes; and
loading the excitation signal to the remaining of the at least two of the transmit electrodes sequentially along the edge-to-center direction from the other end of the arrangement direction of the at least two of the transmit electrodes.

6. The method according to claim 1, wherein
the receive electrodes comprise a plurality of rows of receive electrodes; and the transmit electrodes that finally receive the excitation signal in the plurality of signal load operations one-to-one correspond to the plurality of rows of receive electrodes; and
identifying the fingerprint based on the acquired fingerprint signals comprises:
identifying the fingerprint based on fingerprint signals acquired by each row of receive electrodes.

7. The method according to claim 6, wherein identifying the fingerprint based on the fingerprint signals acquired by each row of receive electrodes comprises:
generating a fingerprint image frame corresponding to each row of receive electrodes based on the fingerprint signal acquired by each row of receive electrodes;
splicing a plurality of fingerprint image frames respectively corresponding to the plurality of rows of receive electrodes to acquire a fingerprint image to be identified; and
identifying the fingerprint image to be identified.

8. The method according to claim 6, wherein the number of transmit electrodes is greater than the number of rows of the receive electrodes.

9. The method according to claim 1, wherein the excitation signal comprises a periodically changing sine wave voltage signal.

10. (canceled)

11. A device for identifying a fingerprint, comprising: an ultrasonic fingerprint sensor, the ultrasonic fingerprint sensor comprising a plurality of transmit electrodes and a plurality of receive electrodes, the transmit electrodes being disposed to face the receive electrodes, the transmit electrodes being strip-shaped, and the receive electrodes being block-shaped; and
the device further comprising: a processor and a memory storing an instruction executable by the processor, wherein the processor,
when executing the at least one instruction, is caused to:
perform a plurality of signal load operations on the transmit electrodes, wherein the signal load operation comprises: loading an excitation signal to at least two of the transmit electrodes sequentially, the at least two of the transmit electrodes being consecutively arranged;
in response to performing the signal load operations on the transmit electrodes, acquire a fingerprint signal by a target electrode of the receive electrodes, the target electrode being a receive electrode facing a transmit electrode that finally receives the excitation signal in one signal load operation; and
identify a fingerprint based on acquired fingerprint signals.

12. The device according to claim 11, wherein the ultrasonic fingerprint sensor further comprises: a piezoelectric material layer disposed between the transmit electrodes and the receive electrodes.

13. The device according to claim 11, wherein the receive electrodes comprise a plurality of rows of receive electrodes, the number of transmit electrodes being greater than the number of rows of the receive electrodes.

14. A display device, comprising: a display panel and the device as defined in claim 11, wherein the ultrasonic fingerprint sensor in the device is disposed on a backlight side of the display panel.

15. A non-transitory computer-readable storage medium storing an instruction therein, wherein the readable storage medium, when run by a processing component, causes the processing component to:
perform a plurality of signal load operations on the transmit electrodes, wherein the signal load operation comprises: loading an excitation signal to at least two of the transmit electrodes sequentially, the at least two of the transmit electrodes being consecutively arranged;
in response to performing the signal load operations on the transmit electrodes, acquire a fingerprint signal by a target electrode of the receive electrodes, the target electrode being a receive electrode facing a transmit electrode that finally receives the excitation signal in one signal load operation; and
identify a fingerprint based on acquired fingerprint signals.

16. The device according to claim 11, wherein in order to load the excitation signal to the at least two of the transmit electrodes sequentially, the processor is caused to:
load the excitation signal to the at least two of the transmit electrodes sequentially along an arrangement direction of the at least two of the transmit electrodes.

17. The device according to claim 11, wherein in order to load the excitation signal to the at least two of the transmit electrodes sequentially, the processor is caused to:
load the excitation signal to the at least two of the transmit electrodes sequentially along an edge-to-center direction from two ends of an arrangement direction of the at least two of the transmit electrodes.

18. The device according to claim 17, wherein in order to load the excitation signal to the at least two of the transmit electrodes sequentially along the edge-to-center direction from the two ends of the arrangement direction of the at least two of the transmit electrodes, the processor is caused to:
load the excitation signal to the at least two of the transmit electrodes sequentially simultaneously along the edge-to-center direction from the two ends of the arrangement direction of the at least two of the transmit electrodes.

19. The device according to claim 17, wherein in order to load the excitation signal to the at least two of the transmit electrodes sequentially along the edge-to-center direction from the two ends of the arrangement direction of the at least two of the transmit electrodes, the processor is caused to:
load the excitation signal to the at least two of the transmit electrodes sequentially along the edge-to-center direction from one end of the arrangement direction of the at least two of the transmit electrodes; and
load the excitation signal to the remaining of the at least two of the transmit electrodes sequentially along the edge-to-center direction from the other end of the arrangement direction of the at least two of the transmit electrodes.

20. The device according to claim 13, wherein the transmit electrodes that finally receive the excitation signal in the plurality of signal load operations one-to-one correspond to the plurality of rows of receive electrodes; and in order to identify the fingerprint based on the acquired fingerprint signals, the processor is caused to:
identify the fingerprint based on fingerprint signals acquired by each row of receive electrodes.

21. The device according to claim 20, wherein in order to identify the fingerprint based on the fingerprint signals acquired by each row of receive electrodes, the processor is caused to:
generate a fingerprint image frame corresponding to each row of receive electrodes based on the fingerprint signal acquired by each row of receive electrodes;
splice a plurality of fingerprint image frames respectively corresponding to the plurality of rows of receive electrodes to acquire a fingerprint image to be identified; and
identify the fingerprint image to be identified.
